(19) United States
(12) Patent Application Publication
(10) Pub. No.: US 2011/0191203 A1
(43) Pub. Date: Aug. 4, 2011

(54) AUTOMOTIVE SALES RESOURCE DEVICE AND METHOD OF USING THE SAME

(76) Inventors: James Braun Hughes, Thousand Oaks, CA (US); Bruce Ira Polkes, Thousand Oaks, CA (US)

(21) Appl. No.: 13/020,611

(22) Filed: Feb. 3, 2011

Related U.S. Application Data
(60) Provisional application No. 61/337,492, filed on Feb. 3, 2010.

(51) Int. Cl. G06Q 30/00

(52) U.S. Cl. 705/26.5; 705/27.2

(57) ABSTRACT

A system and method for providing automotive resource information to a plurality of users can include the use of a plurality of portable devices. Each device has a display screen for displaying information and a storage medium for storing information thereon. The storage medium of each device can contain an application for displaying automotive information on the display screen of the device.

### CROSS REFERENCE TO RELATED APPLICATION

This application claims the benefit of priority of U.S. Provisional Application No. 61/337,492, filed on Feb. 3, 2010, which is herein incorporated by reference in its entirety.

### FIELD

This invention relates generally to the field of automotive sales and more particularly, to a method and system of providing automotive salespeople with filtered sales tools and resources to enhance the sales presentation and delivery process of information outputted to a portable device.

### BACKGROUND

For decades, there has been an old problem of mistrust and customer skepticism during the sales and delivery process. That was largely the case because little of the information about the vehicles for sale was available to the customers. Today, however, customers are much better informed and have tremendous amounts of automotive information available to them. As a result, it is increasingly important for the automotive salesperson to be especially knowledgeable about the vehicles they sell.

Because so much more information is available to customers about available vehicles, customers often arrive at an automotive dealership with their purchase choice narrowed down to one or two vehicles. Having already thoroughly researched the vehicles, the customer may have a few specific questions about these particular vehicles. However, the salespersons likely has dozens or even hundreds of models and trim styles that are sold at his dealership or dealership group and, therefore, may not be fully prepared to answer the customer's specific questions. Thus, the salesperson is not on equal footing with the newly empowered consumer and can lose the sale, sell at a price lower than required, or otherwise deliver the customer a less than satisfactory sales experience.

Although the salesperson may have some information available to him through his desktop computer, if a salesperson sits down at a desk during the process to find an answer to a customer's question, the flow of the salesperson's presentation can be interrupted by delaying the exchange of information and dividing the salesperson from the customer. The salesperson can be “divided” from the customer both physically by the presence of the desk and monitor, and emotionally by the interruption to the sale presentation. Similarly, if the salesperson goes into his sales manager's office to get an answer, this can further interrupt the sales flow and the salesperson may lose the customer's confidence. Moreover, a lot of the questions asked and vehicle information requested happens out on the vehicle lot when a desktop computer is not available, and leaving the lot just to find an answer further interrupts the flow of the sales interaction.

Moreover, most of the resources currently available to automotive salespersons are accessible through the Internet and are grouped by each manufacturer in different manners. This can make it difficult for the salesperson to perform quick research on a specific question while with a customer. Although it may be possible to look up certain information on a small handheld device (such as a mobile phone), the customer cannot see the small display screen and the salesperson cannot easily share the results of the search with the customer. In addition, such smaller handheld devices, like mobile phones, generally do not have sufficient hard drive and memory to operate a powerful desktop resource application independent of a server while the salesperson is out on the sales lot or on a test drive, nor is the mobile connection to the Internet reliable and fast enough to ensure continuous service.

As a result, it is desirable to provide a way to improve the information available to automotive salespeople independent of where they are physically located to ensure that they are providing the customer with a positive experience, while, at the same time, improving the sales numbers of the dealership by converting a high ratio of potential buyers to satisfied and loyal customers.

### SUMMARY

As discussed above, the ability of salespeople to provide accurate, up-to-date and extensive information to their customers while remaining engaged in the developing relationship is not possible with the conventional tools and resources that are currently available. Thus, there is a need for a customized, consolidated sales resource application that can be accessed via a device that has a display screen that is large enough for the customer to share the display and mobile enough for the salesperson to move around the sales lot and away from the dealership without the risk of losing a connection with the resource application. Moreover, the extensive filtering and presentation of the content is preferably performed by the sales resource application instead of the salesperson who generally has limited access to such information and the time necessary to provide and develop this information.

In a first embodiment, an automotive sales resource application can be provided on and accessed by a device that can be used by sales consultants during a sales presentation with a customer. The device can be a mobile device, slate, tablet, booklet PCs or other similar portable device with a screen. The application is preferably developed as a web portal/mashup. The application can provide the sales consultants with all the sales tools and resources that they require within a single application. The application preferably contains object-oriented and/or aggregated automotive content and links customized by manufacturer, Region/Zip Code, dealership and buyer.

The embodiments described below preferably include the presentation of objective, unbiased information such as specifications, pricing, competitive comparisons, owner videos, blog quotes and trade-in valuations, etc. By being object-oriented and aggregated content, the information is provided in logical “buckets” that can be easily accessed regardless of which manufacturer or model/trim the customer is interested in. The object-oriented aggregated data can be quickly updated based on regional rebates and financing incentives and each dealership can upload customized content to contain their “steps to the sell” and policy guides. Buyer response information can prioritize the presentation of object-oriented data based on driving needs, location, and financing requirements. In contrast to conventional website development, the application's preferred use of an object-oriented structure and special content mapping codes enables quick updating of the content and links without having to republish or redesign the application.

The application resources described herein can be used with devices, such as mobile devices or tablets, that can update their information so that each salesperson has access to current and updated information that they can share with the customer as desired. The device can wirelessly communicate with and interact with the portal/mashup and/or they can run software applications installed on the devices so that they can operate as independent devices that allows the information to be accessed or displayed even when the device is out of range of a server or other such local system.

In another embodiment, a system is provided with a rack in which a plurality of sales consultant tablets can be stored when not in use. The rack can be configured to provide charging capabilities as well as a secure locking and monitoring system so that each tablet can only be removed from the rack by a designated sales consultant. Preferably, the rack is configured so that the release of one or more tablets cannot be achieved unless a security access requirement is met, such as the entry of a proper security code or the use of a fingerprint reader. Each tablet can be provided with a tracking device, such as an RFID tag or GPS locater that can track the movement or otherwise identify the location of the tablet when removed from the rack. The rack can also serve as an interface to various other devices at the dealership, such as a driver's license scanner that enables the salesperson to record data from the customer's driver's license into a contact management system. Similarly, the tablet itself can be provided with or directly coupled to such devices to facilitate the scanning of information or other desired operations.

In another embodiment described herein, the system can provide for real-time tracking for each individual device as well as the totality of the collections of devices, that enables the sales management to monitor which pages of the sales application were utilized, the order they were accessed, and for how long, and even which vehicles were scanned or shown to a customer. This information can be used by the dealership to optimize their sales process, determine the usefulness of various pages or operations, and coach/train their Sales Consultants. Future updates or modifications can take such information into consideration.

Another aspect of the application is the use of a bar-code reader that can quickly match a vehicle bar-code to resource data for that vehicle, displaying VIN-specific information, and an optional camera that enables the salesperson to take a picture of the customer and their trade-in and provide that information to the sales manager wirelessly during the sales process. The RFID reader can recognize tags put in various locations of a showroom demonstration model and alert the salesperson to options that need to be featured or tags on vehicles on the sales lot that have special pricing or sales incentives.

In another aspect, personal computers in a various styles and sizes, such as kiosks, thin clients, Smartphone, notebooks, laptops and PDAs can use some of the features of the sales resource; for example an Internet manager can access the application via a desktop or laptop PC while on the phone with an online buyer. A customer visiting the dealership while having repair work performed can use a kiosk, laptop or their PDA connected to the dealership's free wireless network to do research about their next vehicle purchase within the dealership's site/portal/mashup, instead of browsing other dealership websites. A Finance and Insurance manager can use the information gathered during the sales cycle to complete the required paperwork or transfer the data to a more traditional legacy system used to manage the dealership or a 3rd party customer relationship management system via an export feature.

The foregoing and other features and advantages of the various embodiments will become more apparent from the following detailed description, which proceeds with reference to the accompanying figures.

### BRIEF DESCRIPTION OF THE DRAWINGS

FIG. 1 shows a schematic block diagram of an embodiment of an apparatus for providing an automotive sales resource application to a device.

FIG. 2 illustrates the application and database and how it uses mapping codes to provide object-oriented or aggregated automotive content.

FIG. 3 shows a flowchart of an embodiment of a method for providing the various resources to the salesperson.

FIG. 4A-D shows examples of the object-oriented or aggregated automotive content and links used by the automotive sales resource application.

FIG. 5 illustrates a chart of the widening gap of knowledge between salespersons and potential customers.

FIG. 6 illustrates various embodiments of devices in use and in storage configurations.

FIG. 7 illustrates an embodiment of a device that can display and present automotive information.

FIGS. 8A-8C shows examples of automotive content that can be displayed and presented using the automotive sales resource application and device.

FIG. 9 illustrates a screenshot of a customer priority selection tool.

FIG. 10 illustrates a screenshot of a home screen with various links to access information about a selected vehicle.

FIG. 11A illustrates a screenshot of a plurality of information that can be accessed specific to an area of the vehicle (a “walkaround”), linked to a view of a vehicle that has been selected for consideration.

FIG. 11B illustrates a screenshot of walkaround information combined from a plurality of sources, and presented in a singular format, with convenient links to related media.

FIG. 12 illustrates a screenshot of a plurality of multimedia applications relating to technical features of a vehicle that has been selected for consideration.

FIG. 13 illustrates a screenshot of an available inventory of vehicles.

FIG. 14 illustrates a screenshot of certain preferences available for user to customize the display on the device.

FIG. 15 illustrates a summary of information about a vehicle selected for considerations.

FIG. 16 illustrates a screenshot of additional functions available in FIG. 15 and provides a means to email or print that summary information, or collect customer data (e.g. name, address, phone number) that will be sent directly to the dealer's CRM system.

FIG. 17 illustrates a screenshot of a dealer portal showing dealer information and dealer's ability to edit same.

FIG. 18 illustrates a screenshot of a dealer portal showing customization options and dealer's ability to edit same.

FIG. 19 illustrates a screenshot of a dealer portal showing user information and the registered devices in the system, and dealer's ability to edit and manage them directly, including ability to block an individual device.

### DETAILED DESCRIPTION

Described herein is a novel method and system for providing an automotive sales resource application. The novel method and system is described below.

The following description is exemplary in nature and is not intended to limit the scope, applicability, or configuration of the invention in any way. Various changes to the described embodiment may be made in the function and arrangement of the elements described herein without departing from the scope of the invention.

As used in this application and in the claims, the singular forms “a,” “an,” and “the” include the plural forms unless the context clearly dictates otherwise. Additionally, the term “includes” means “comprises.” Further, the term “associated” generally mean electrically, electromagnetically, and/or physically (e.g., mechanically or chemically) coupled or linked and does not exclude the presence of intermediate elements between the coupled or associated items absent specific contrary language.

Although the operations of exemplary embodiments of the disclosed method may be described in a particular, sequential order for convenient presentation, it should be understood that disclosed embodiments can encompass an order of operations other than the particular, sequential order disclosed. For example, operations described sequentially may in some cases be rearranged or performed concurrently. Further, descriptions and disclosures provided in association with one particular embodiment are not limited to that embodiment, and may be applied to any embodiment disclosed.

Moreover, for the sake of simplicity, the attached figures may not show the various ways (readily discernable, based on this disclosure, by one of ordinary skill in the art) in which the disclosed system, method, and apparatus can be used in combination with other systems, methods, and apparatuses. Additionally, the description sometimes uses terms such as “produce” and “provide” to describe the disclosed method. These terms are high-level abstractions of the actual operations that can be performed. The actual operations that correspond to these terms can vary depending on the particular implementation and are, based on this disclosure, readily discernible by one of ordinary skill in the art.

The systems and methods described herein may be implemented or performed by software stored on one or more tangible computer-readable media (e.g., one or more optical media discs, volatile memory or storage components (such as DRAM or SRAM), or nonvolatile memory or storage components (such as hard drives)) and executed on one or more computing systems. The computing systems can include one or more central processing units (CPUs) and a memory, such as random access memory (RAM) for temporary storage of information and/or a read only memory (ROM) for permanent storage of information, and a mass storage device, such as a hard drive, diskette, or optical media storage device.

Such software can be executed on a single computer or on a networked computer (e.g., via the Internet, a wide-area network, a local-area network, a client-server network, or other such network). The systems and methods disclosed herein can also be performed using cloud computing, a form of Internet-based computing, whereby shared resources, software and information are provided to computers and other devices on-demand. The software embodiments disclosed herein can be described in the general context of computer-executable instructions, such as those included in program modules, which can be executed in a computing environment on a target real or virtual processor.

Furthermore, any of the software embodiments (comprising, for example, computer-executable instructions for causing a computer to perform any of the disclosed methods) can be transmitted, received, or accessed through a suitable communication means. Similarly, any data structure, data file, intermediate result, or final result created or modified using any of the disclosed methods can be transmitted, received, or accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means now known or unknown. Moreover, any data structure, data file, intermediate result, or final result produced by any of the disclosed methods can be displayed to a user using a suitable display device (e.g., a computer monitor or display). Such displaying can be performed as part of a computer-implemented method of performing any of the disclosed methods.

The computing systems on which the methods and systems disclosed herein can be implemented are hereinafter referred to as “devices”. Such devices can include mobile phones (e.g., iPhones™, Android™ phones, or other such smart phones), personal digital assistants, portable computers such as tablets or laptops, or other similar devices that can implement the methods described herein.

As used herein, the terms “tablet”, “tablet devices”, or “tablet-like device” means a slate, tablet, or booklet PC, or other similar portable device that has a display screen that is at least five inches, as measured diagonally across the display. A booklet is a type of tablet PC with dual screens that opens and shuts like a book, but otherwise functions like a slate. In preferred embodiments, the tablet-like device preferably has a display screen that is greater than 7 inches, and even more preferably, greater than 10 inches, as measured diagonally across the display.

Software configured to operate and run the methods and systems disclosed herein can be licensed and/or purchased by customers for use with, for example, the devices described above. In some embodiments, the software can comprise application software that is specifically configured to run on various devices. For example, the software can be an “app” available from a source that provides software via a website or service. Such media stores include, for example, Apple's iTunes Store, App Catalog by Palm Inc., Android Market, Windows Marketplace for Mobile by Microsoft, the Ovi store by Nokia, and BlackBerry App World by Research in Motion. Information available on the “apps” can be updated regularly without having to re-download the app so that each device running the app has current and updated information about the vehicles available for purchase. Moreover, as described in more detail below, each dealership can update the information provided on the app separately from other dealerships.

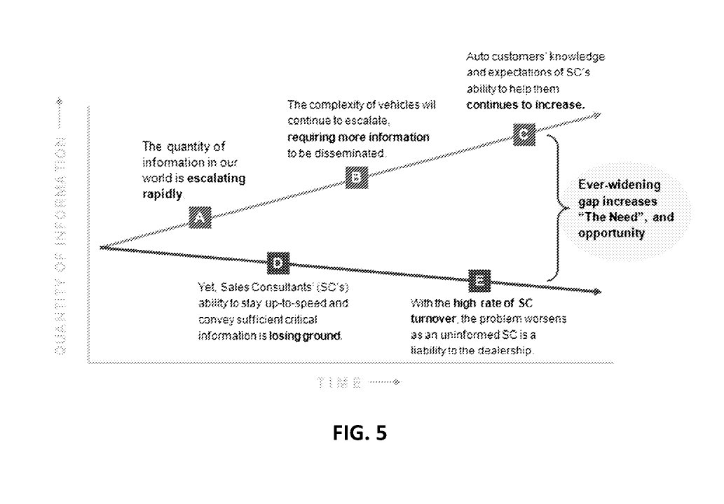

As noted above, there is an increasing need for automotive salespersons to be able to stay up-to-speed and convey critical information to increasingly well-informed customers. FIG. 5 illustrates a graph that shows the ever-widening gap between the information available to a customer and the information that conventional salespeople may have at their fingertips. The systems and methods described below greatly reduce this gap and provide salespersons with the necessary tools and information to provide high-quality and informative sales presentations to customers.

As shown and discussed in detail below, the system can comprise an application and/or a customized web portal that contains all the salespersons tools organized in an intuitive manner, enabling them to respond quickly to customer's information needs. Moreover, the portal can be customized for each brand, Region/Zip Code, dealership, etc.

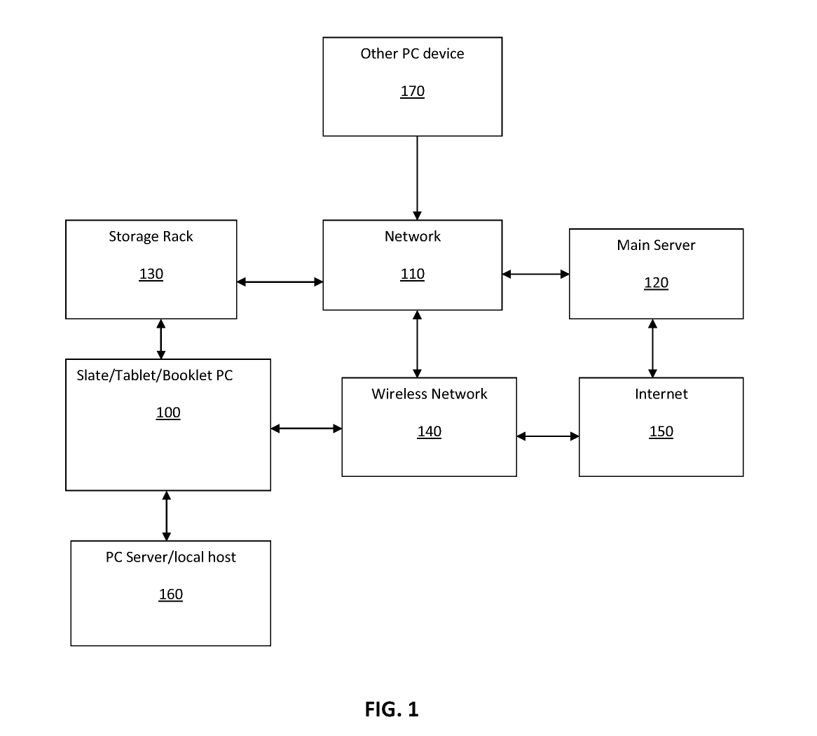

FIG. 1 shows one embodiment of a basic system associated with the automotive sales resource application. As shown in FIG. 1, the system can include a device (e.g., a slate/tablet/booklet PC) 100, network 110, server 120, storage rack 130, wireless network 140 and Internet 150.

Device 100 can be equipped with a touch screen, multitouch or graphics tablet/screen-hybrid to operate the computer with a stylus or digital pen, or a fingertip(s), instead of a keyboard, touchpad or mouse although some tablets have convertible features to enable keyboard, touchpad and mouse input. The device can be capable of sending and receiving messages and data to and from another computer device, including the Main Server 120, Wireless Network 140 and Internet 150.

The device can contain its own PC server/local host 160 created with an Apache, Windows or other HTTP server software that operates independent of the Main Server 120 or the Internet 150. Local host is the hostname given to the address of the loopback network interface. The loopback directs a web browser installed on the slate/table/booklet PC running the HTTP server to http://localhost and will display the home page of the sales resource application. Communicating with the loopback interface in an identical manner as with Main Server 120 on the Wireless Network 140, but bypassing the local network interface hardware and useful for when the salesperson leaves the range of the Wireless Network 140.

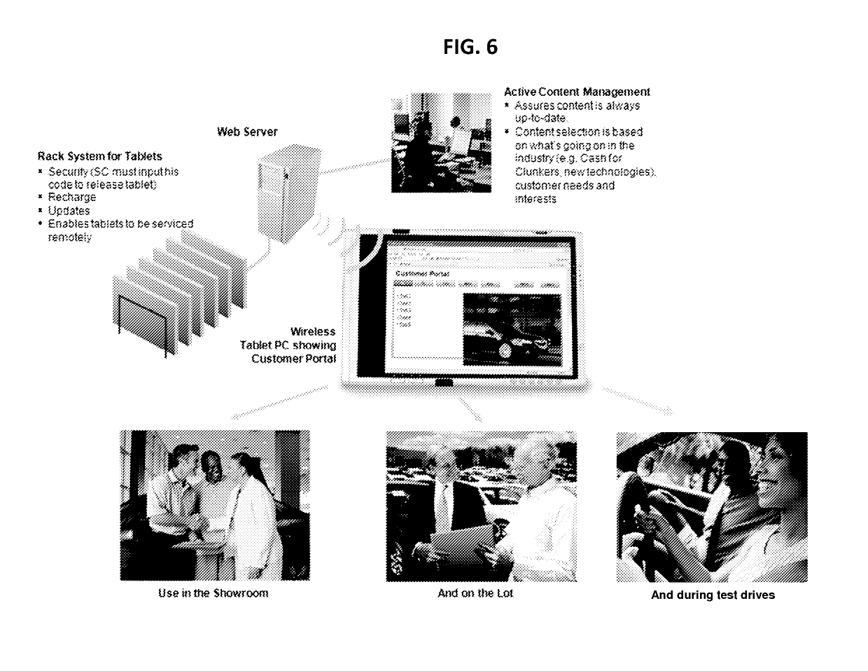

As shown in FIG. 6, the device can be stored in a Storage Rack 130 when not in use. Preferably, the Storage Rack 130 is capable of securing a plurality of devices. Storage Rack 130 can be a security and charging unit that also provides the device a connection to the Network 110 and Main Server 120. Thus, when not in use, the device can be docked into the rack providing AC power, a security lock, and a Network 110 connection to the Main Server 120. Preferably, each of the devices 100 can be updated periodically or in real-time, so each device contains the same information. Thus, each device can be updated with accurate inventory information so that each salesperson is able to determine whether a particular vehicle is in stock or not. Similarly, each device is preferably updated with the same content (as described below) so that a salesperson need not select the same device each time, he or she will be able to use any available device and know that the device that was selected is up-to-date. The system and content updates can be periodic or they can be performed in real-time (at least for some updates). Also, the updates can be wirelessly delivered to the devices or they can be delivered when the devices are docked in the Storage Rack 130 and connected to Network 110.

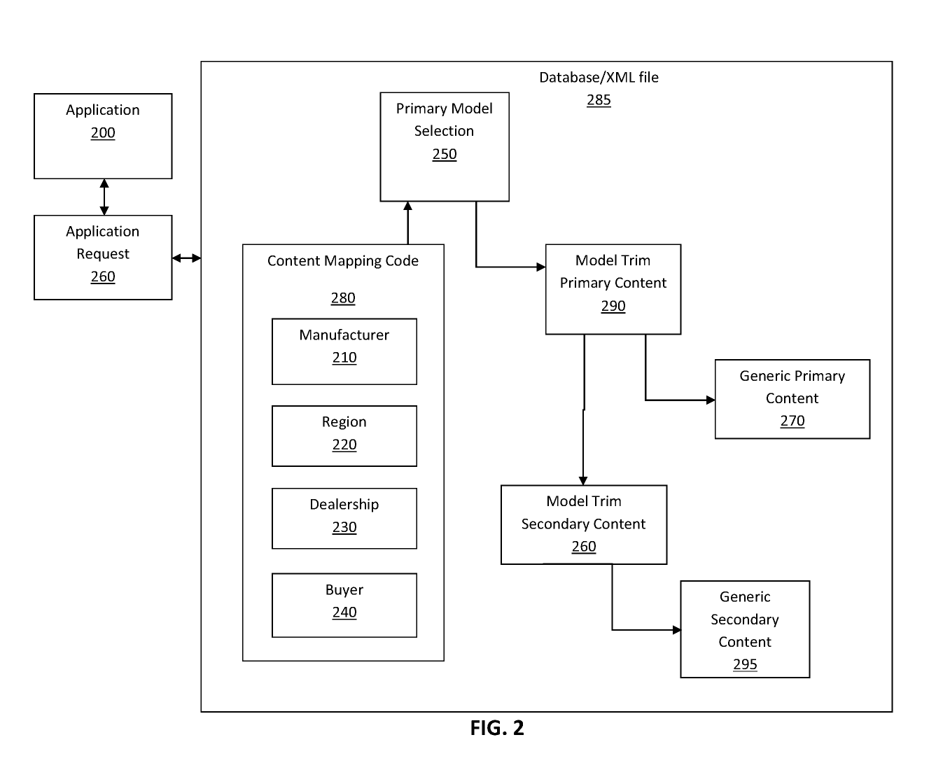

The Main Server 120 can be a computer system that is designated for running the applications required to store and present the information shown in more detail below in FIG. 2. Main Server 120 may consist of a single server computer or it may comprise multiple server computers. The information and data can be transferred to and from the device 100 and server 120 via wireless network 140. Network 110 can be any type of network capable of transferring electronic information and may include, for example, the Internet, local area network (LANs), wide area networks (WANs), or any combination of thereof. Device 100 can transmit and receive information and data over a wireless network 140, which, in turn, can connect to network 110 and to server 120. The wireless network can be any known wireless network, including a cellular network.

Additional information and details concerning wireless networks and methods of communicating between computers, mobile devices, and servers can be found in United States Patent Publication No. 2006/0059160 A1 to Smola et al., the entirety of which is hereby incorporated by reference.

It should be understood that for each step described below, communication with server 120 can be achieved by inputting information into an input device associated with device 100. The system can be configured so that other PC devices 170 (e.g., a laptop, desktop, kiosk, or thin client device) can access the information stored on the network. In addition, information received from server 120 can be viewed on a screen or other information display of device 100 and/or PC device 170.

FIG. 2 shows the Application 200 for interacting with device 100. The Application 200 contains object-oriented or aggregated automotive content and links that uses an Application Request 260 and a Content Mapping Code 280 stored in Database/XML file 285 that link to each Manufacturer 210, Region or Zip Code 220, Dealership 230 and Buyer 240 to the content. By using a hierarchical structure as described below, the information can be presented in a variety of manners, depending on preferences or demands of the manufacturer, dealership, buyer, or region/zip in which the device is being used. It should also be noted that the various manufacturer, dealership, buyer, or region/zip preferences and designations can be combined, so that, for example, a particular dealership preference can be combined with the regional preferences to result in a comprehensive sorting and display of the options associated with that dealership and that region/zip.

This mapping and filtering display by the sales resource application is in contrast to how most Internet consumer vehicle content websites store videos and graphics in folders and then “call” the display through a conventional HTTP-type request. Generally, Internet consumer websites use a method where a browser used by an end-user submits the HTTP request and the responding server, which stores or creates resources such as HTML, Flash, and other files, responds by presenting the display of the graphic, information, or video.

For example, a typical HTTP request on a manufacturer's website is as follows: http://www.acura.com/VideoGallery.aspx?model=MDX&modelYear=2009&context=photos-videos#/video11. The HTTP request is for a file (i.e., video 11) that is stored in the “photos-videos” folder of the Acura website. When model MDX is selected by the user, video 11—a flash file—plays, regardless of the information about the MDX that the consumer was seeking.

Conversely, in the sales resource applications described herein, the “video 11” can be stored in an object-oriented Database/XML file 285 with a Mapping Code 280. An example of this Mapping Code 280 would be Video AC MDX AWD 2009 FrankAc 72

AC—Manufacturer 210, Acura

MDX—Primary Model 250, MDX

AWD—Model Trim 290

2009—Year, 2009, Filtered for Buyer 240

FrankAc—Frank Acura of Orlando, Dealership 230

72,—Region/Zip Code 220

The Mapping Code 280, stored in separate fields in the Database/XML file 285, determines what is presented when an Application Request 260 is issued. The information can be sorted by the type of information the Dealership 230 or Manufacturer 210 want to present. Similarly, the information can be sorted by the Region/Zip Code 220 or the Buyer 240. Option packages often vary by Region/Zip Code, so it can be helpful to sort the information that is available by Region/Zip Code.

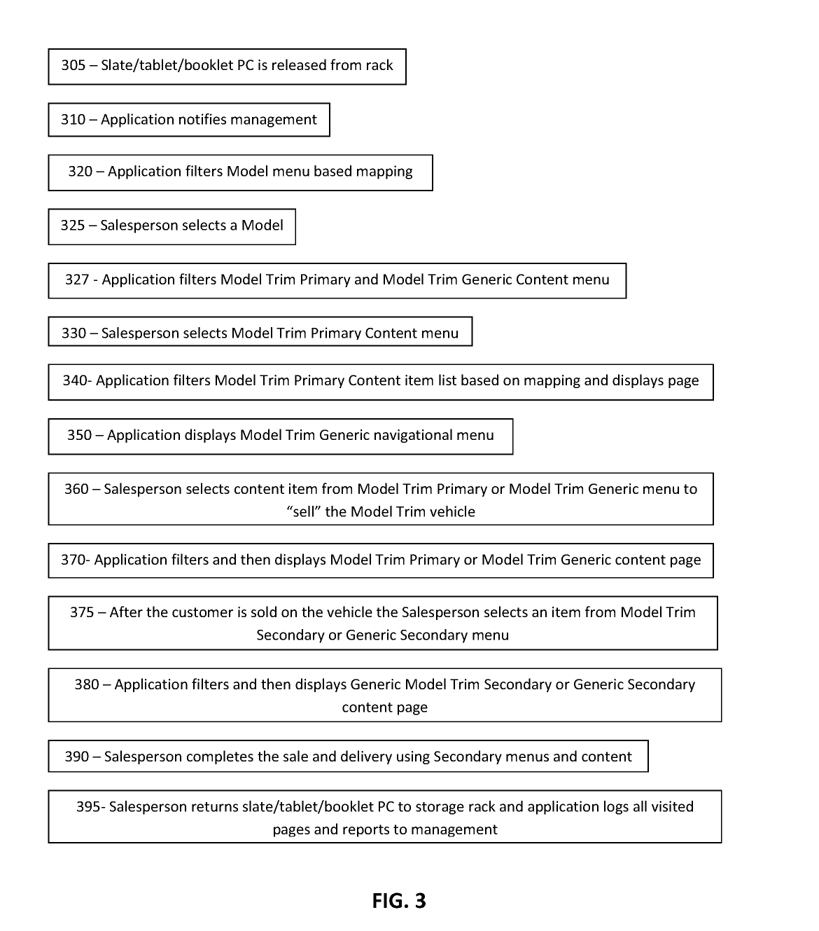

For example, if Manufacturer 210 or Dealership 230 does not want videos used in their sales resource application because of slower hardware, lack of content available or because it interrupts the sales process, then this video 11 would not play when the salesperson selects a Primary Model 250 screen and the MDX AWD model/trim. Thus, the information displayed when a model is selected (e.g., Model Trim Primary Content 290) can be filtered based on the Mapping Code 280. This process is explained in more detail in the flowchart of FIG. 3 below.

The displayed content can also be determined based on real-time availability of vehicles. For example, Manufacturer 210 or Dealership 230 might not have any 2009 MDX AWD model/trim left, so they do not want the salesperson showing a video of that obsolete year/model/trim, thus, the system can be configured to not provide certain information (e.g., such as the video on the MDX) about any models that are not currently in stock or otherwise available. Thus, the system can be configured to not play the MDX video because the model is out of stock.

Alternatively, the Buyer 240 might not be interested in the older model, so again, the video would not play based on the filtering of the Application Request 260 command issued by the Application 200 and based on the Mapping Code 280 stored in the Database/XML file 285 of the video content.

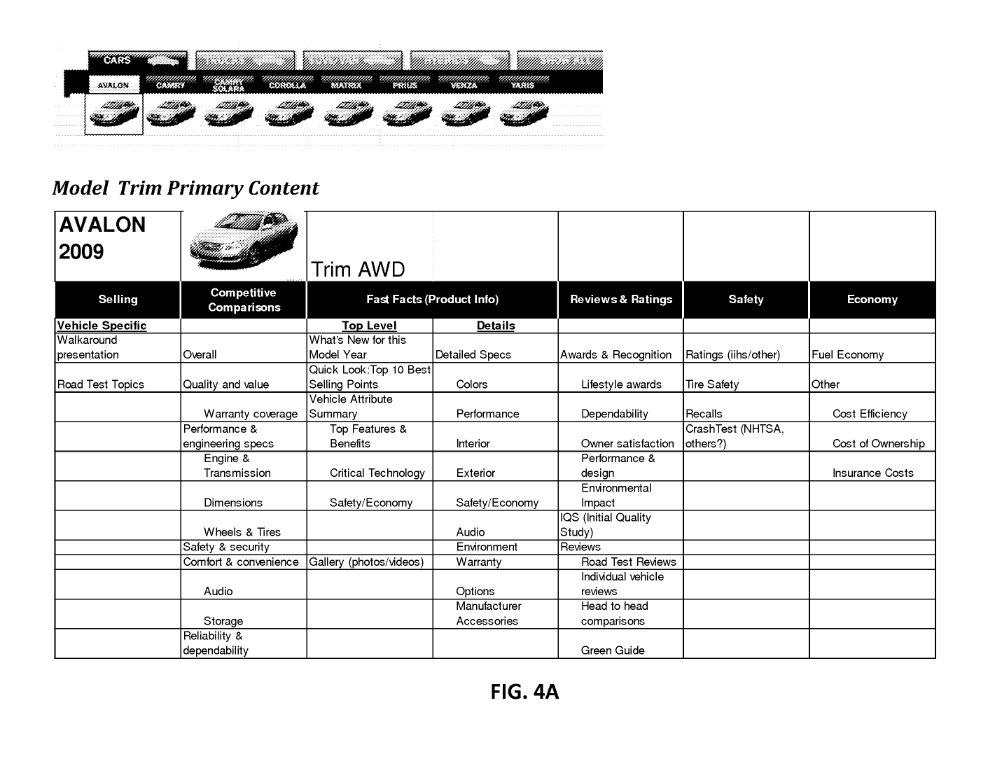

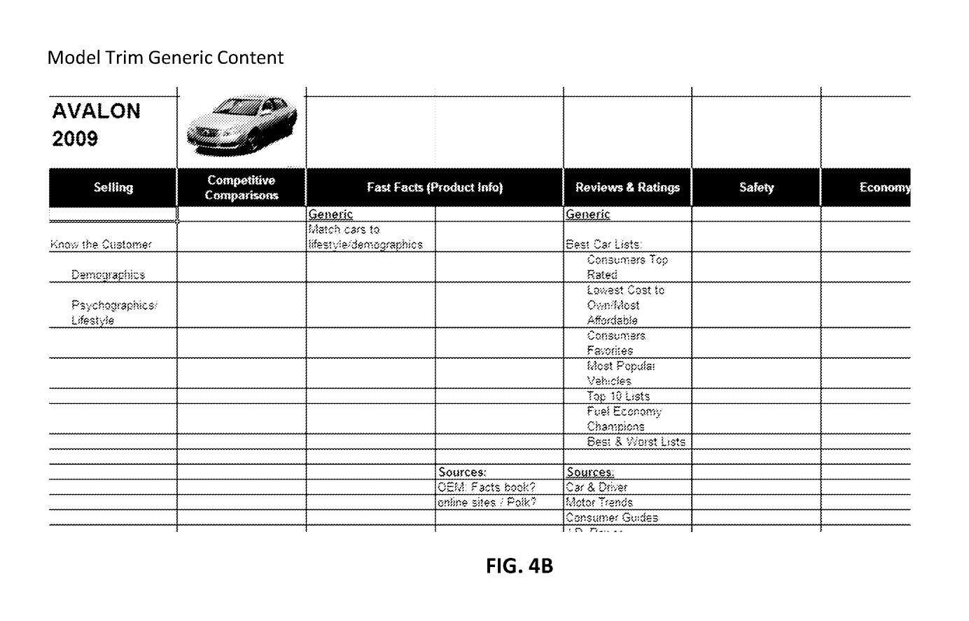

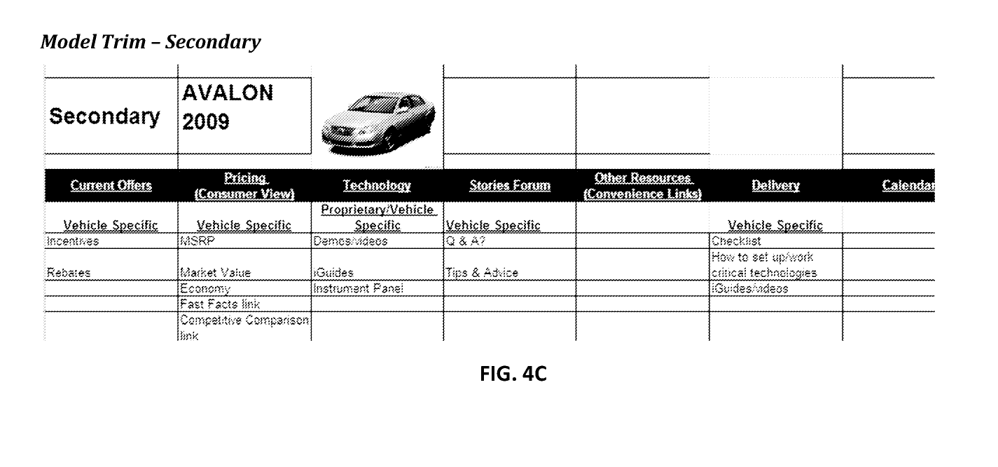

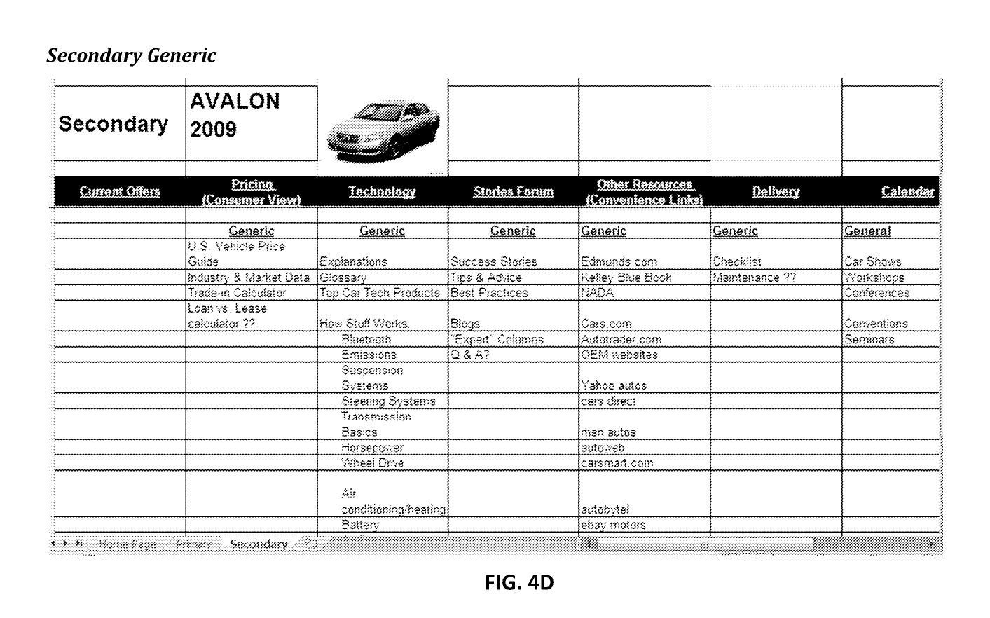

The sales resource application also contains both Secondary and Generic content that can be presented regardless of the Manufacturer 210 or Primary Model 250 but can be filtered based on Region/Zip Code 220, Dealership 230, and Buyer 240. An example of this Generic Primary 270 content would be a Best Car Lists that applies to the automotive industry and does not require but can be filtered by the Application 200, Application Request 260 or the Mapping Code 280. But when a Model Trim has been selected and if the selected Model Trim is NOT on the Best Car List, then the Best Car List does not display. This is explained in more detail in FIG. 3 and FIGS. 4A-D.

A Generic Secondary Content 295 could be a Car Show date on the Calendar that doesn't matter if a Model Trim vehicle has been selected or not. The Generic Primary Content 270, Generic Secondary Content 295 along with the Primary Model 250 selection filtering process will be detailed in FIG. 3 and examples shown in FIGS. 4A-D.

FIG. 3 is a flow chart illustrating steps of an embodiment of the novel method and system of providing resources to a salesperson. Step 300 involves the salesperson performing a security function that could be a fingerprint scan, login, swiping an employee ID or driver's license into a reader or checking out from another staff member. Step 305 releases the device 100 from the Storage Rack 130. The step is performed by the application's interface to the Storage Rack. In step 310, the Application 200 notifies management that could be either via an alert to their desktop PC, an SMS message to their cell phone, or an email. The notification can indicate that a salesperson has activated a device 100 and it can identify which salesperson activated the device. The Content Mapping Code 280, described in FIG. 2, can filter the Models that are displayed on the menu in step 320.

Primary Model Selection

In step 325, the salesperson can select a Model and the application can filter the Model Trim Primary and Model Trim Generic menu in step 327. Referring to FIG. 4A, the selection of the Model can comprise an action where the salesperson selects a tab displayed on the screen of the device. Preferably, while the salesperson's input device hovers on that tab or taps it, the various models under that tab are displayed and can be selected. Similarly, when the salesperson's input device hovers over the model in that tab or taps it, the system can display which trim levels are available for selection.

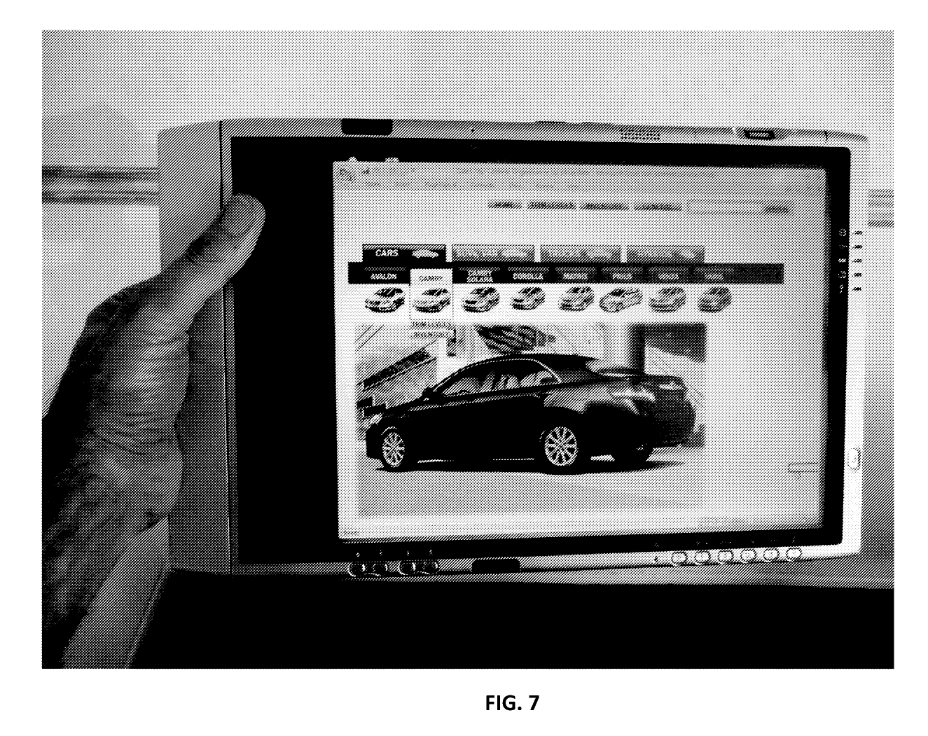

Once the model is selected, the system can present the salesperson with a Primary menu. For example, FIG. 7 illustrates a device showing a car (e.g., the Camry) selected with two options—trim levels and inventory—available to be selected. Each model can have many different trim levels (versions of the model). For example, in 2010 the Toyota Avalon has an XL, XLS and Limited Trim option. The application can provide the requisite filtering based on mapping to determine which items are displayed.

Model Trim Selection and Filtering of Primary and Generic Menus

In step 330, the salesperson can select the Model Trim Primary Content menu and then in step 340 the Application can filter Model Trim Primary and Generic content items based on mapping and display the results on a page. This can include all the detail about the selected Model Trim including options that are standard and option packages. More examples of detail are shown in FIGS. 4A-D. The Application also displays the Model Trim's Generic menu in Step 350 and the in Step 360 the salesperson can select and view content from the Primary item list and hover over the generic menu and generic item lists and when the salesperson selects an item, the application filters and displays in step 370 this Primary and Generic content for the originally selected Model Trim vehicle for any of the items as part of this novel presentation and selling method.

Displaying Model Trim Content

An example of the Application's filtering of two menu items is described below in connection with Model Trim Primary Content 290 (a menu item), Awards & Recognition (a content item), Model Trim Generic Primary Content 270 (a menu item), and Best Car List (a content item).

If the selected Model Trim vehicle is not included on the Best Car List—nor has it received any Awards & Recognition—then neither of these two menu items would appear when the particular vehicle is selected. This novel method of filtering and mapping of the content prevents the salesperson from displaying information that is not helpful to the sales presentation, such as a Best Car List that doesn't contain the vehicle that the customer is interested in purchasing.

The drop-down menus or other types of item lists can be created using any of various computer scripting languages, such as Flex, or AJAX scripting for PHP. Model Trim Primary Content items can have content for just the selected Model Trim, while Model Trim Generic Primary Content items can contain information about the selected Model Trim vehicle and more Generic content as well. Referring again to the above example, if the vehicle was selected as “Best New Sedan,” the Award & Recognition could identify the selected Model Trim as the “Best New Sedan” for the year and an article about why the selected Model Trim was chosen for this award. In contrast, if the car was on a Best Car List along with other vehicles, information about the other vehicles can be sorted out as being not helpful to the sales presentation. The novel method of separating and mapping this content from Model Trim Primary to Model Trim Generic Primary can help the salesperson identify information that is helpful and eliminate the delivery of generic information that is not specific to the model selected.

Both of these Primary Content menus (Model Trim and Generic) have the “primary” purpose of providing the information with useful information about the selected Model Trim. If the customer decides that this is the vehicle they want to purchase, the Secondary menus can be use to finalize the sale and deliver.

Model Trim Secondary and Generic Secondary Menu Selection

Both Secondary menus; Model Trim Secondary Content 260 and Generic Secondary Content 295 can be accessed either directly from the home page or from the Model Trim Primary menu. The Application displays both the Model Trim Secondary and Generic Secondary navigational menu 375 based on the mapping. In step 375 a salesperson can select a content item from Model Trim Secondary. An example of one of these items is a list of the Rebates available for that Model Trim that is selected. A Secondary Generic tool can be a Lease vs. Purchase calculator that helps the customer decide if leasing is a better option. In step 380 Application filters and then displays this Generic Model Trim Secondary or Generic Secondary content page. The content presentation in the Secondary menu can have the most variety. An example of this could be a guide on How Stuff Works, explaining Bluetooth, Emissions, Suspension Systems, Steering Systems, Transmission Basics, Horsepower, and Wheel Drive. This could be presented in a PDF book format where the pages turn back and forth. This guide might be on the Model Trim Secondary menu if specific to a certain Model Trim and another version might be on the Generic Secondary if the guide was universal to all vehicle makes and models. Using this content in step 390, the salesperson completes the sale and delivery using Secondary menus and content like the trade-in valuation calculator or delivery checklist A more detailed list of the content and its organization by Primary and Secondary along with Generic is showed in FIGS. 4A-D. When done, the salesperson can return the device to storage rack in step 395 and application logs all visited pages and provides a report to management.

FIGS. 4A-4D show examples of computer screen content items that can be displayed associated with the salesperson's selection of a Model Trim and then broken down into Primary and Generic Primary along with Secondary and Generic Secondary. As discussed in more detail below, FIG. 4A shows examples of 6 Primary Content categories from which the salesperson can select filtered by the selected Model Trim. FIG. 4B shows the more Generic content grouped under the Primary content categories that can be selected for the Model trim by hovering over the generic menu, selecting an icon, or it might appear faded or a different color or shade behind the Primary content. Another option is that it could be a side tab. FIG. 4C shows 8 category examples of Secondary content for the selected Model Trim. These resources help complete the sale and delivery of the selected vehicle. Like the Primary Generic it might be accessed by hovering over the Secondary menu, selecting an icon, or it might appear faded or a different color or shade behind the Model Trim Primary content. FIG. 4 D shows Secondary Generic content that might not even depend on the selected Make/Model/Trim or contain content particular to the selected Model/Trim. It is still presented in the same 8 categories as the Model Trim Secondary menu and might be accessed by hovering over the Model Trim Generic menu, Model Trim Secondary Menu or even on all pages of the application.

FIG. 4A illustrates an embodiment of information that can be displayed with Model Trim—Primary Content 290. In the exemplary figure, FIG. 4A illustrates six categories: selling, competitive comparisons, fast facts (product info), reviews and ratings, safety, and economy. Although six categories are shown, it should be understood that more or fewer categories can be included in this category and in each of the other categories described herein. Also, the options under each of the 6 categories can change depending on which Model/Trim has been selected. However, as shown in FIG. 4A, at least the following information can be provided.

1) Selling
a) Walk around presentation
b) Road Test Topics

2) Competitive Comparisons
a) Overall
b) Quality and value
c) Warranty coverage
d) Performance & engineering specs
e) Engine & Transmission
f) Dimensions
g) Wheels & Tires
h) Safety & security
i) Comfort & convenience
j) Audio
k) Storage
l) Reliability & dependability
m) Pricing
n) Advantages
o) Fuel Economy
p) Environment
q) Owner Satisfaction
r) Photos
s) Competitive Ads

3) Fast Facts (Product Info)
a) Top Level
   i) What's New for this Model Year
   ii) Quick Look: Top 10 Best Selling Points
   iii) Vehicle Attribute Summary
   iv) Top Features & Benefits
   v) Critical Technology
   vi) Safety/Economy
   vii) Gallery (photos/videos)
      (1) Details
         (a) Detailed Specs
         (b) Colors
         (c) Performance
         (d) Interior
         (e) Exterior
         (f) Safety/Economy
         (g) Audio
         (h) Environment
         (i) Warranty
         (j) Options
         (k) Manufacturer Accessories

4) Reviews & Ratings
a) Awards & Recognition
b) Lifestyle awards
c) Dependability
d) Owner satisfaction
e) Performance & design
f) Environmental Impact
g) IQS (Initial Quality Study)
h) Reviews
i) Road Test Reviews
j) Individual vehicle reviews
k) Head to head comparisons
l) Green Guide
m) Buying Guides
n) Recalls

5) Safety
a) Ratings (iihs/other)
b) Tire Safety
c) Recalls
d) Crash Test (NHTSA, others)

6) Economy
a) Fuel Economy
b) Other
c) Cost Efficiency
d) Cost of Ownership
e) Insurance Costs

FIG. 4B illustrates various features that can be shown under Model Trim Primary Generic 270. The options under each of the 6 categories can change depending on which Model/Trim is selected but can also contain more “generic” information about all vehicles

1) Selling
a) Match cars to lifestyle/demographics

2) Competitive Comparisons

3) Fast Facts (Product Info)
a) Top Level
b) Details

4) Reviews & Ratings
a) Best Car Lists
b) Consumers Top Rated
c) Lowest Cost to Own/Most Affordable
d) Consumers Favorites
e) Most Popular Vehicles
f) Top 10 Lists
g) Fuel Economy Champions
h) Best & Worst Lists

5) Safety

6) Economy

FIG. 4C illustrates various features that can be included under Model Trim Secondary 260. The options under each of the 8 categories change based on Model/Trim selected and are presented later in the sales process. These resources help complete the sale and delivery of the selected vehicle, and can include, for example, the following:

1) Current Offers
a) Incentives
b) Rebates

2) Pricing—Consumer View
a) MSRP
b) Market Value
c) Economy
d) Fast Facts link
e) Competitive Comparison link

3) Technology
a) Demos/videos
b) iGuides
c) Instrument Panel

4) Stories Forum
a) Q & A?
b) Tips & Advice

5) Other Resources (Convenience Links)

6) Delivery
a) Checklist
b) How to set up/work critical technologies
c) iGuides/videos

7) Calendar

8) Search

FIG. 4D illustrates features and information that can be included within a Generic Secondary 295 grouping. The options under each of the 8 categories change are the most generic and might not even depend on the selected Make/Model/Trim or contain content particular to the selected Model/Trim. For example, the features and information under this category can include:

1) Current Offers
a) Dealership specials

2) Pricing—Consumer View
a) U.S. Vehicle Price Guide
b) Industry & Market Data
c) Trade-in Calculator
d) Loan vs. Lease calculator

3) Technology
a) Explanations
b) Glossary
c) Top Car Tech Products
d) How Stuff Works:
e) Bluetooth
f) Emissions
g) Suspension Systems
h) Steering Systems
i) Transmission Basics
j) Horsepower
k) Wheel Drive
l) Air conditioning/heating
m) Battery
n) Audio
o) Electronics

4) Stories Forum
a) Success Stories
b) Tips & Advice
c) Best Practices
d) Blogs
e) “Expert” Columns

5) Other Resources (Convenience Links)
a) Edmunds.com
b) Kelley Blue Book
c) NADA
d) Cars.com
e) Autotrader.com
f) OEM websites
g) Yahoo autos
h) cars direct
i) msn autos
j) autoweb
k) carsmart.com
l) autobytel
m) eBay motors
n) nhtsa
o) CARFAX
p) Auto Week
q) Automotive News
r) Google search
s) J.D. Power

6) Delivery
a) Checklist
b) Maintenance

7) Calendar
a) Car Shows
b) Workshops
c) Conferences
d) Conventions
e) Seminars

8) Search

A primary benefit of the use of the Content Mapping Code 280 and hierarchical structure of the system is that it can be easily customized by a dealership to provide accurate, up-to-date information at the fingertips of its salespeople. Because this information can be provided in a portable device, the information can be accessed and provided to the customer while the salesperson is in the showroom or elsewhere outside the showroom (FIG. 6).

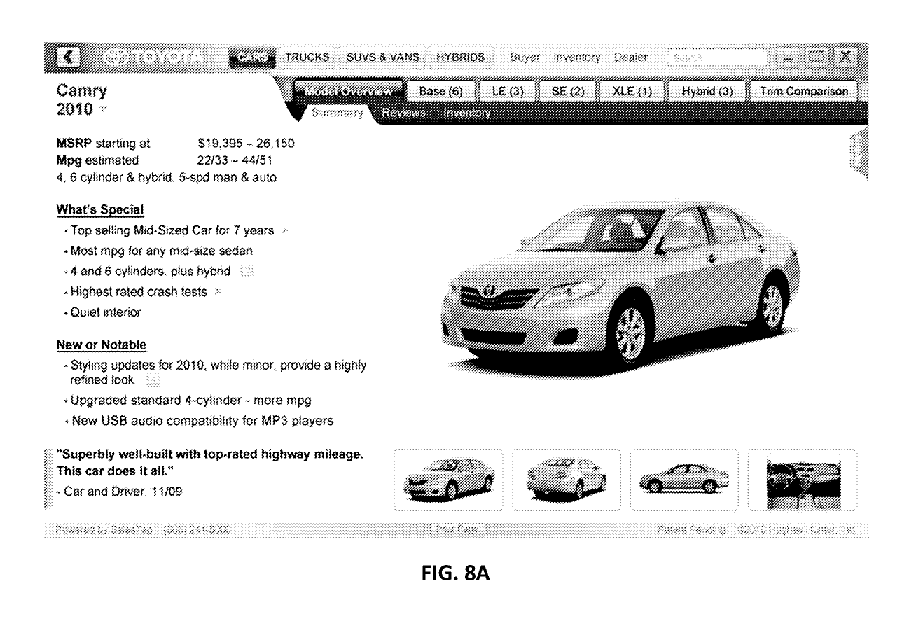

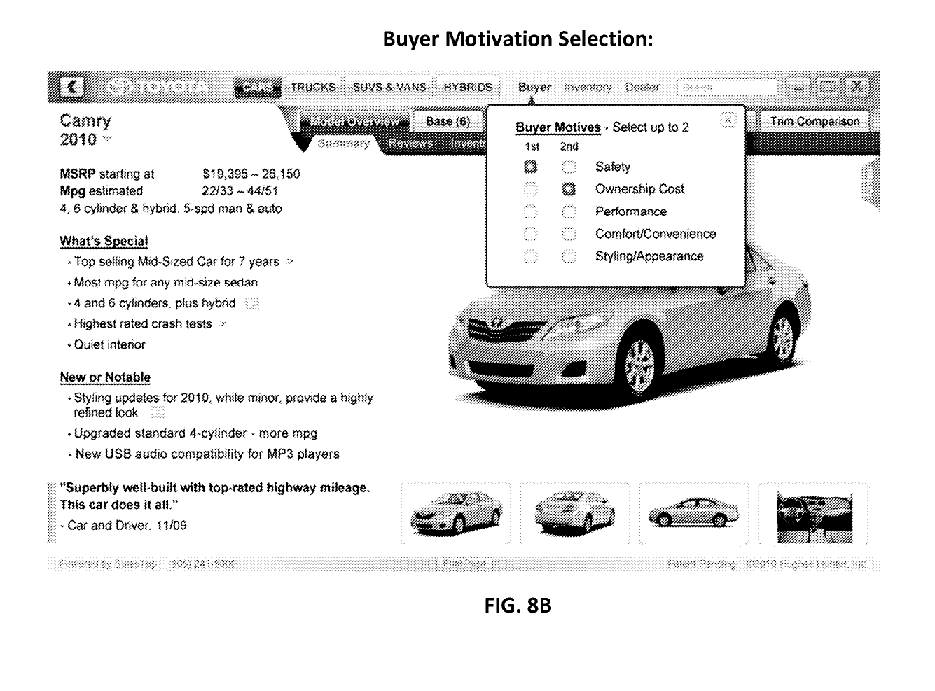

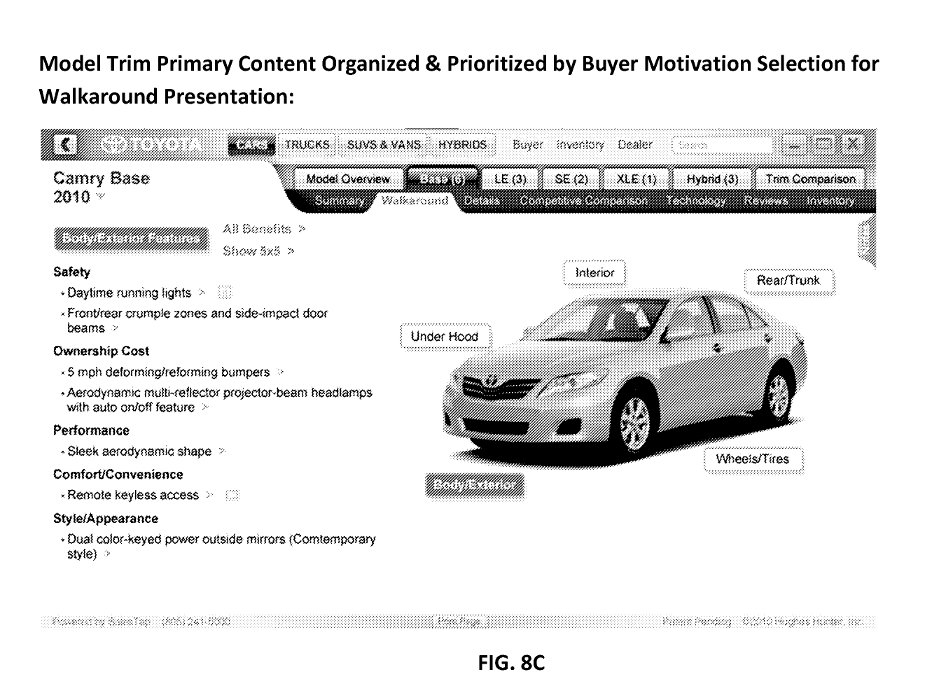

FIGS. 8A-8C illustrate additional examples (e.g., screenshots) of the type of content and information that can be displayed on the devices described herein. For example, FIG. 8A illustrates summary information that can be displayed on a selected model (e.g., Camry 2010). The summary information can display various general type of information, each of which can be linked to a more detailed source. For example, a quote from a Car and Driver review can be provided. By clicking or otherwise selecting a link associated with that quote, the full review can be retrieved and presented on the device for a potential customer to view.

FIG. 8B illustrates an example of how the displayed automotive information can be buyer customized. For example, the buyer can identify his or her primary motives or desires and based on those factors, the vehicles that are available can be ranked. Thus, the buyer can designate one or more of the following as motives or desired features that are important to the buyer: safety, cost, performance, comfort/convenience, styling appearance. Of course, other aspects can be used for such buyer customization of the presented information.

FIG. 8C illustrates another example of other automotive information that can be displayed on a device. In the example shown in FIG. 8C, the information displayed relates to the various features of the exterior of the selected vehicle. As discussed above with respect to FIG. 8B, the displayed information can be ranked and displayed in the order of importance to the buyer based on their identification of motives and desires.

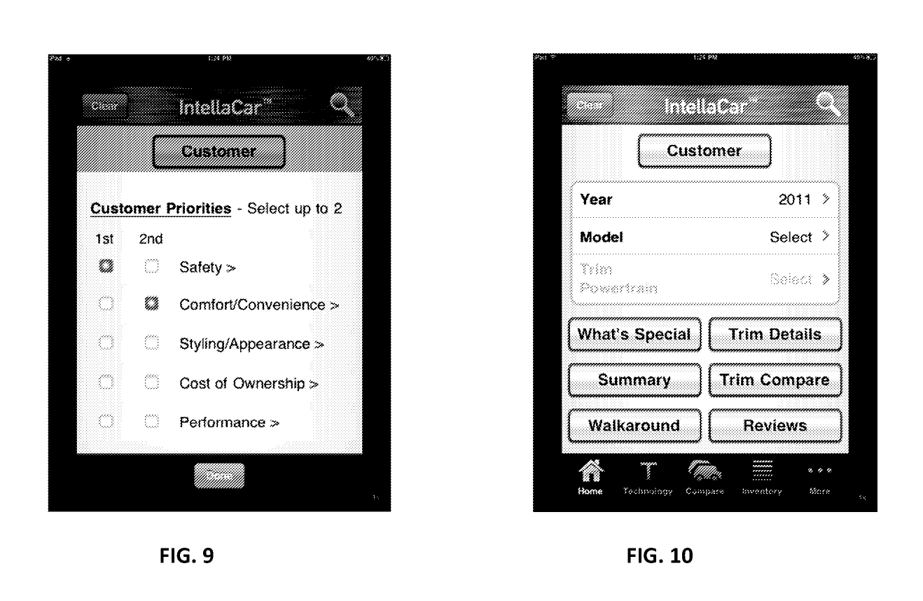

FIGS. 9-16 illustrate the methods and systems described herein in operation on other devices, such as iPhones running “apps.” It should be understood, however, that the basic features and operations are generally identical and/or substantially similar to those described above. A new customer can be entered and saved in the system. For example, although the screenshots depicted herein show the generic term “customer”, that field can be updated to identify the customer by name (e.g., “John Doe”). In this manner, information associated with each customer can be stored and retrieved later if desired. Thus, a customer can leave the dealership and return at a later date without having to repeat his or her preferences to another salesperson.

FIG. 9 illustrates a screenshot of a device displaying a system requesting the selection of one or more customer priorities. The customer can rate his or her priority with regard to various features, such as, for example, safety, comfort/convenience, styling/appearance, cost of ownership, and performance. After the customer indicates his or her preferences, the customer or salesperson can select “done” and the information presented about each chosen vehicle will be ordered according to the priorities chosen by the customer.

If the customer or salesperson is looking for information about a particular vehicle, FIG. 10 illustrates a “home” screen from where vehicles and various trim selections for a particular vehicle can be selected. From this screen, various other features can of the system can be accessed, including, for example, listings of: special features of a vehicle (“what's special”), trim details, a summary of features, trim comparisons, multimedia views and information (“walkaround”), and reviews of the vehicle.

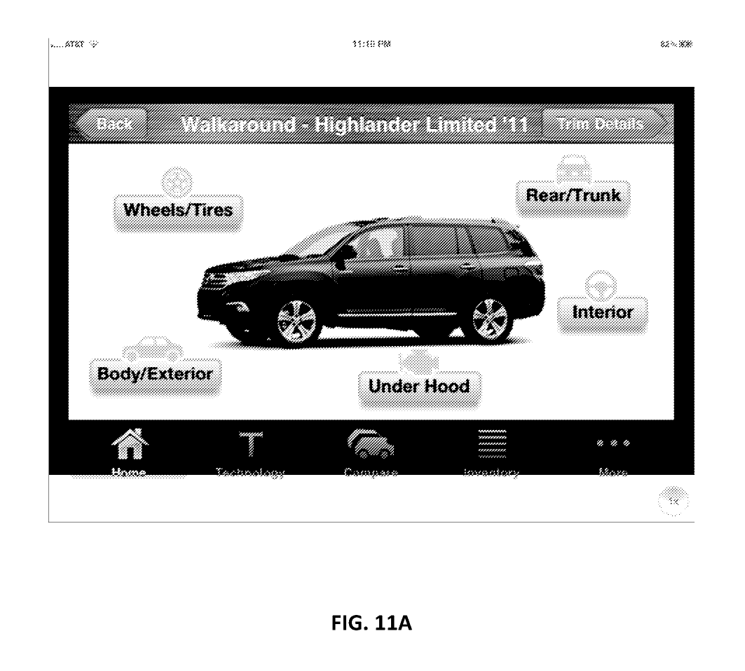

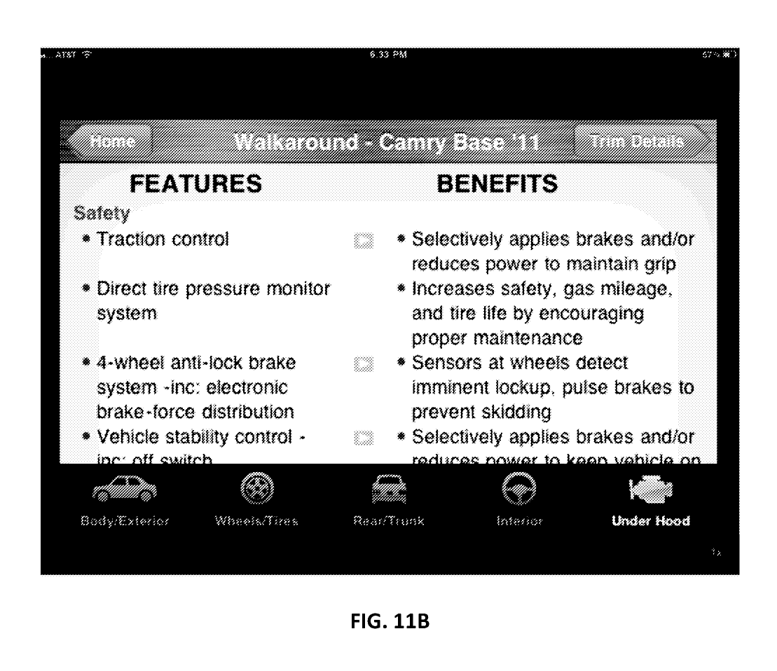

Upon selection of “Walkaround” from the screen shown in FIG. 10, a new screen can be presented with a graphical representation of the vehicle in consideration. From this location, various other information relating to the vehicle can be easily and quickly accessed. For example, by selecting the “walkaround” icon, the user can view the screenshot shown in FIG. 11. The “walkaround” view in FIG. 11 links the user to video, pictures, and/or other textual information about the vehicle including, for example, information about the wheels/tires, body/exterior, engine (under hood), interior, and rear/trunk.

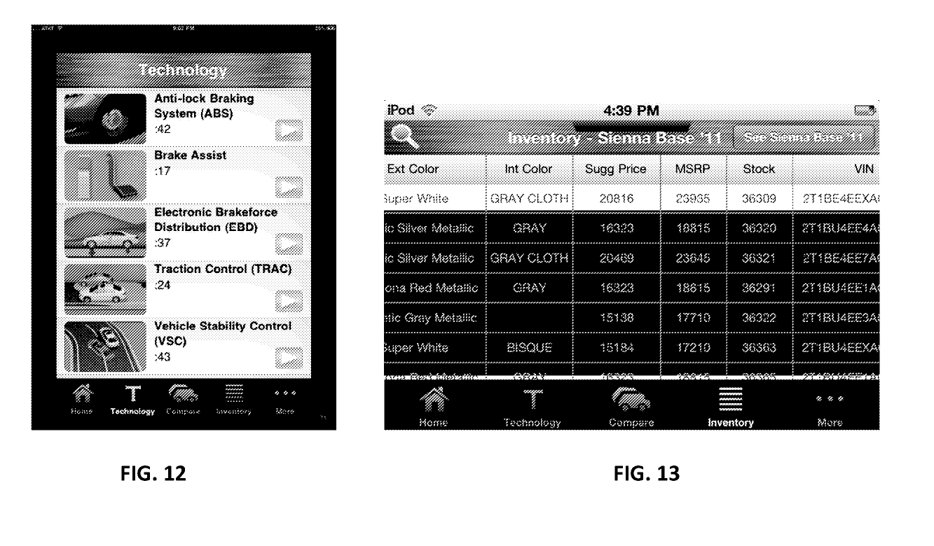

As shown in FIG. 10, other features and information can be accessed by selecting “Technology”, “Compare”, “Inventory”, or “More”, which are located along the bottom of the screen in the screenshot of FIG. 10. For example, FIG. 12 illustrates a screenshot that can be shown when the user selects “Technology.” FIG. 12 includes multimedia information about various technical features of the vehicle in consideration. Upon selecting the “inventory” icon, a listing of the inventory available for purchase (e.g., either onsite or otherwise obtainable by the salesperson) can be shown as illustrated in FIG. 13.

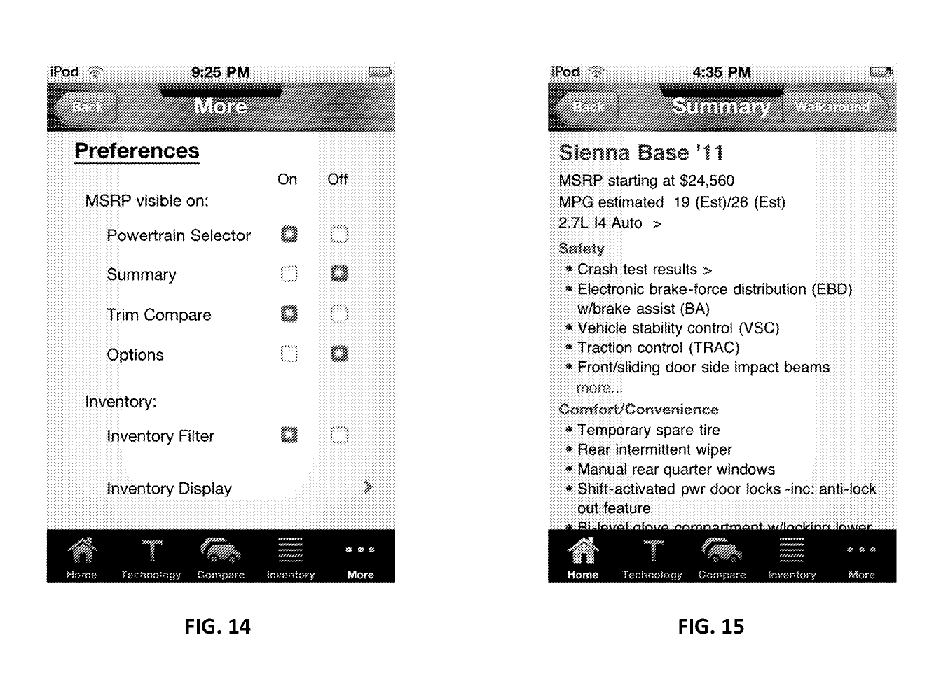

FIG. 14 illustrates a screenshot of a configuration whereby the user can select display preferences appropriate for the individual customer or for that user across multiple customers (e.g. whether the Manufacturer's Suggested Retail Price appears or not).

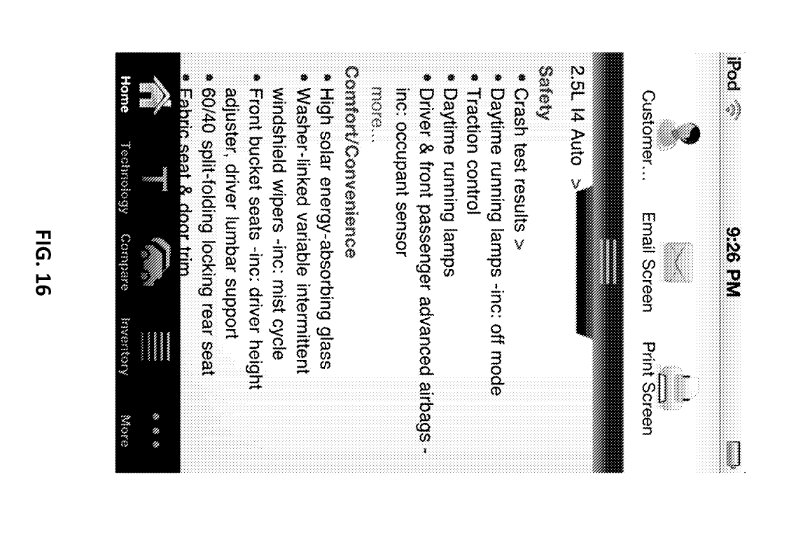

Referring again to FIG. 10, if the user would like to review a summary of the information about a vehicle being considered, the user can select the “Summary” feature. As shown in FIG. 15, a summary of any relevant or desired features can be shown on the screen of the device. Moreover, as shown in FIG. 16, the user can also print, email, and/or otherwise access that information to deliver and/or provide that information to the customer.

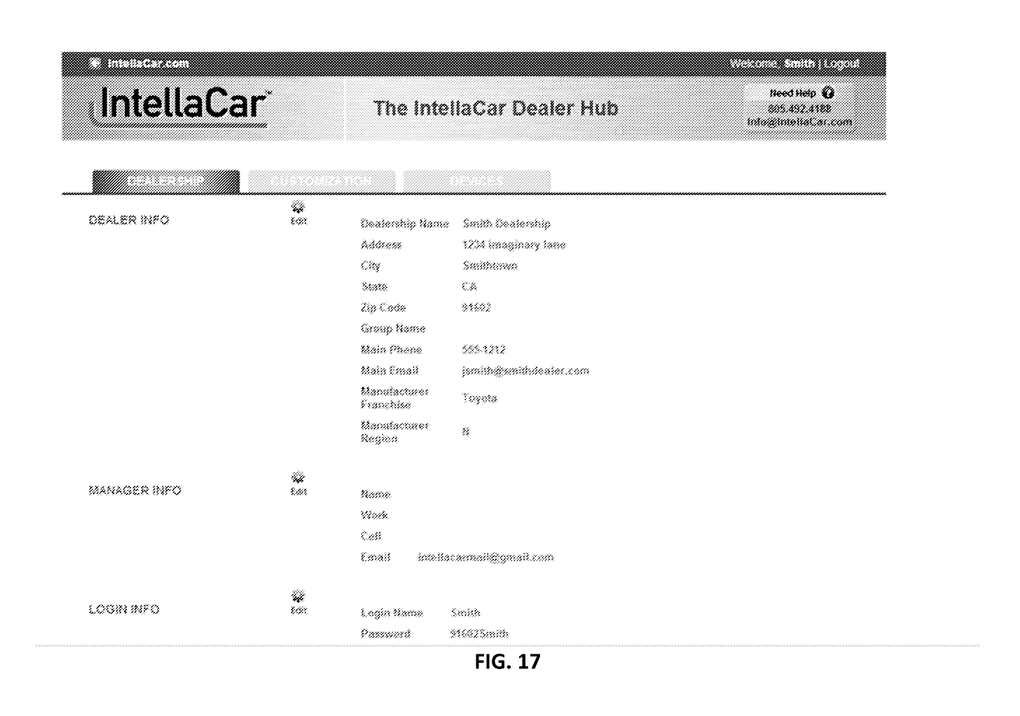

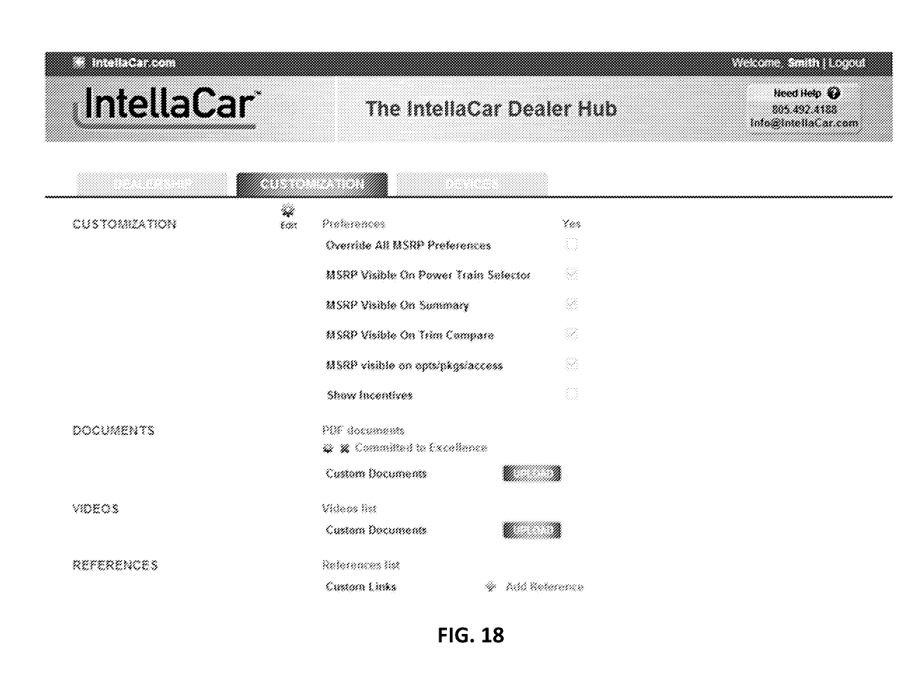

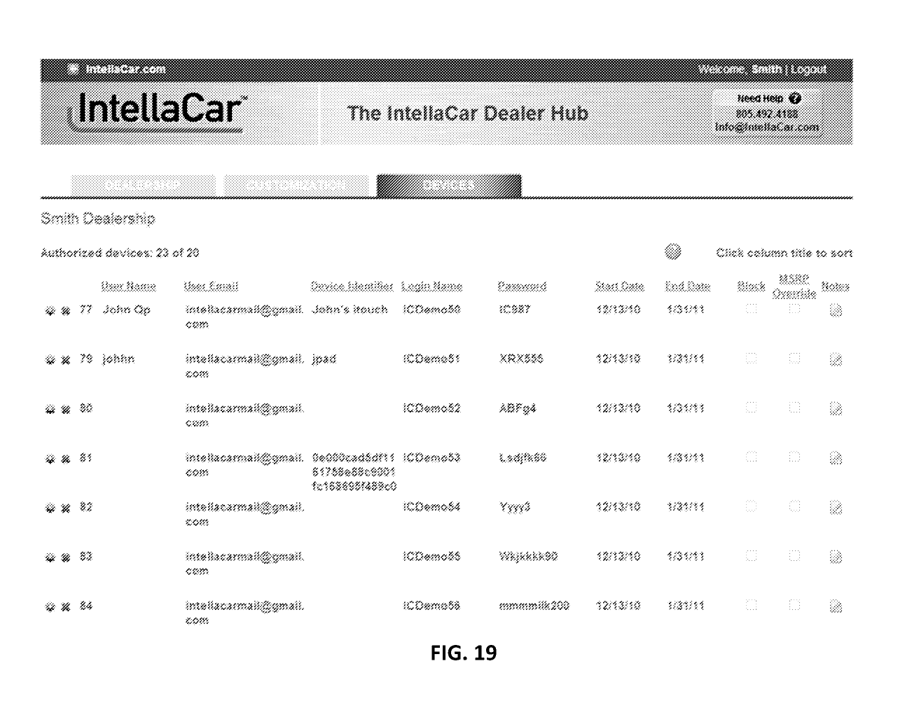

FIGS. 17-19 illustrate a dealer portal by which a dealer and/or the users associated with the dealership can enter, manage and store information about the users and the preferences of the dealership and/or its users, as well as add documents, videos, or links specific to that dealership.

The systems and methods described herein can provide increased vehicle sales, higher close rates, higher customer satisfaction scores (CSI), and a significant sales paradigm shift where the sales team becomes sharper and more effective than ever before. Moreover, these systems and methods are very “green”, since it is all electronic and can greatly reduce the need for print materials.

These systems and methods also increases a salesperson's ability to solve customer problems, answer questions, and educate the customer about the vehicles they are interested in, while at the same time delighting the customer with new valuable or interesting information in a way that builds credibility and adds value to the sales presentation on the spot. Such systems can also improve the confidence of the sales staff since they can greatly reduce the burden of having to “learn it all” to avoid being embarrassed by increasingly well-informed customers. Moreover, such systems enables salespersons to focus on getting proficient at accessing information versus memorizing the information, which can greatly reduce the time it takes for a new salesperson to become effective at his or her job.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. A system for providing automotive resource information to a plurality of users, the system comprising:
a plurality of devices, each device having a display screen for displaying information and a storage medium for storing information thereon; and
wherein the storage medium of each tablet contains an application for displaying automotive information on the display screen of the device.

2. The system of claim 1, wherein the devices comprise tablet devices, the system further comprising a storage rack for holding the plurality of tablet devices.

3. The system of claim 2, wherein the storage rack comprises a security system that restricts removal of the tablet devices from the storage rack, and
wherein each tablet device is individually secured within the storage rack by the security system, and each tablet device can be individually removed from the storage rack by establishing or providing a security access function.

4. The system of claim 1, wherein the automotive information can be customized for use at a plurality of different businesses, such that the automotive information available for display on the devices at a first business can be different from the automotive information at a second business.

5. The system of claim 4, wherein the automotive information provided on each device at each respective business is substantially identical.

6. The system of claim 4, wherein each business is provided a business control panel for managing all of the devices associated with that business.

7. The system of claim 6, wherein the control panel is configured to select and update information available for each of the devices associated with that business.

8. The system of claim 6, further comprising a user control panel, the user control panel being configured to allow a user to select various preferences regarding the display of information on a particular device.

9. The system of claim 1, wherein the application comprises automotive content that can be sorted based on availability of a vehicle at a dealership.

10. The system of claim 9, wherein the application is configured to receive one or more of a buyer's preferences of automotive attributes that they are looking for in a vehicle, and wherein the selection of one or more preferences causes a first set of information contained in the application to display on the display screen as a priority, and causes a second set of information contained in the application from being displayed on the display screen as a second priority.

11. The system of claim 10, wherein the first set of information comprises a first set of vehicle option packages that are available for purchase.

12. The system of claim 11, wherein the device displays a plurality of links to information about the vehicles available for purchase.

13. The system of claim 12, wherein the automotive information comprises object-oriented content.

14. The system of claim 1, wherein the automotive information comprises vehicle specifications, vehicle pricing information, and vehicle comparisons.

15. The system of claim 1, wherein the presentation of object-oriented data can be based on a response from a potential buyer.

16. The system of claim 15, wherein the response includes an indication of at least one or more of a driving need, location, or financing requirement of the buyer.

17. The system of claim 15, wherein the automotive information is updated in substantially real time.

18. A method for using an automotive sales resource, the method comprising:
receiving information about the inventory of vehicles available at a dealership;
delivering that information to a plurality of devices capable of displaying information about the vehicles available for sale at the dealership so that the delivered information can be displayed to a customer interested in purchasing the vehicle model.

19. The method of claim 18, further comprising tracking at least some of the automotive information displayed on the display screen of each device to identify the frequency of use of the automotive information.

20. The method of claim 18, further comprising updating the application to provide a new set of automotive information, wherein each device is updated substantially in real time to contain the same information.

21. The method of claim 20, wherein the automotive information comprises vehicle specifications, vehicle pricing information, and vehicle comparisons.

22. The method of 18, wherein the act of displaying the automotive information comprises walking to a vehicle of interest to a consumer and displaying the automotive information in the vicinity of the vehicle of interest.

23. The method of claim 18, further comprising a dealership control panel, the method comprising:
managing all of the devices at the dealership; and
managing information and preferences associated with all of the devices at the dealership.

24. The method of claim 23, wherein the updating of information via the dealership control panel causes a respective update of the information contained on each device.

25. The method of claim 23, further comprising a user control panel provided with each device, the method comprising:
receiving one or more personal preferences via the user control panel to set preferences for individual devices at the dealership.
